(19) United States
(12) Patent Application Publication
(10) Pub. No.: US 2025/0300799 A1
(43) Pub. Date: Sep. 25, 2025

(54) METHODS, ARCHITECTURES, APPARATUSES AND SYSTEMS FOR JOINT BEAM MANAGEMENT IN NR-DUPLEX

(71) Applicant: InterDigital Patent Holdings, Inc., Wilmington, DE (US)

(72) Inventors: Nazli Khan Beigi, Longueuil (CA); Jonghyun Park, Syosset, NY (US); Moon-II Lee, Melville, NY (US); Paul Marinier, Brossard (CA)

(21) Appl. No.: 18/860,470

(22) PCT Filed: Apr. 25, 2023
(86) PCT No.: PCT/US2023/019825

§ 371 Date: Oct. 25, 2024

Related U.S. Application Data
(60) Provisional application No. 63/334,713, filed on Apr. 26, 2022.

(51) Int. Cl. H04L 5/14; H04L 5/00; H04W 72/541

(52) U.S. Cl. CPC H04L 5/1461; H04L 5/0094; H04W 72/541

(57) ABSTRACT

Procedures, methods, architectures, apparatuses, systems, devices, and computer program products for joint beam management. A first wireless transmit-receive unit, WTRU, may be subject to radio signal interference caused by a second WTRU. The first WTRU may receive, from a network node, information relative to measurement configuration and measurement configuration and reporting configuration for at least one channel quality reference signal received by the first WTRU from the second WTRU. The first WTRU may determine channel quality per WTRU panel/beam index and per the at least one channel quality reference signal received by the first WTRU from the second WTRU according to the measurement configuration received. The first WTRU may report, to the network node, channel state information based on the determined channel quality, according to the reporting configuration received. The network node may then instruct, for example, the second WTRU to avoid transmitting in the direction of the first WTRU.

### CROSS-REFERENCE TO RELATED APPLICATIONS

This application claims the benefit of U.S. Provisional Patent Application No. 63/334,713 filed 26 Apr. 2022, which is incorporated herein by reference.

### FIELD

The present disclosure is generally directed to the fields of communications, software and encoding, including, for example, to methods, architectures, apparatuses, systems directed to joint beam management in NR (New Radio)-duplex.

### BACKGROUND

In RAN #94-e, RAN study item on NR duplex operation has been agreed. This technology could be the great foundation in improving conventional TDD (Time-Division Duplexing) operation by enhancing UL (Uplink) coverage, improving capacity, reducing latency, and so forth. The conventional TDD is based on splitting the time domain between the uplink and downlink. In NR Rel.18, the feasibility of allowing full duplex, or more specifically, cross division duplex (XDD) that is subband non-overlapping full duplex at the gNB side within a conventional TDD band is investigated. The realization of XDD is subject to resolving challenges raised due to cross-link interferences (CLI).

The present document addresses at least some of these challenges.

### SUMMARY

There is disclosed a method, implemented by a WTRU. The method is implemented by a first wireless transmit-receive unit, WTRU. Wireless communication between the first WTRU and a network node is subject to cross-link interference, CLI. The method comprises receiving, from the network node, information indicating a measurement configuration and reporting configuration for a plurality of sounding reference signals, SRS, to be received by the first WTRU. The method comprises measuring, according to the measurement configuration received, for at least a subset of the plurality of SRS received by the first WTRU, CLI per WTRU beam index. The method comprises determining, based on the measurements, a pair of indices. The pair of WTRU indices comprising a WTRU beam index and an SRS resource index of the at least a subset of the plurality of SRS received by the first WTRU. The method comprises reporting to the network node. The reporting comprising the determined pair of indices, the determined pair of indices corresponding to at least one of a strongest CLI or a weakest CLI measured.

The present disclosure also relates to a first wireless transmit-receive unit (WTRU) comprising at least one processor. The at least one processor being configured to receive, from the network node, information indicating a measurement configuration and reporting configuration for a plurality of sounding reference signals, SRS, to be received by the first WTRU. The at least one processor being configured to measure, according to the measurement configuration received, for at least a subset of the plurality of SRS received by the first WTRU, CLI per WTRU beam index. The at least one processor being configured todetermine, based on the measurements, a pair of indices comprising a WTRU beam index and an SRS resource index of the at least a subset of the plurality of SRS received by the first WTRU. The at least one processor being configured to report to the network node, the reporting comprising the determined pair of indices, the determined pair of indices corresponding to at least one of a strongest CLI or a weakest CLI measured.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 shows a technique of Cross-Division Duplex (XDD);

FIG. 3 shows inter-gNB and inter-WTRU (Wireless Transmit-Receive Unit) cross-link interference (CLI);

FIG. 4 shows a potential victim WTRU subjected to RF interference from an aggressor WTRU in its communications with a gNB;

FIGS. 5 and 6 show an example of SB-wise beam reporting based on association of victim WTRU CRI (CSI-RS resource indicator) and aggressor WTRU SRI (SRS Resource Indicator, where SRS stands for Sounding Reference Signal) with reference to the situation depicted in FIG. 4;

FIG. 7 shows coordinated beam avoidance based on null space from the aggressor WTRU; and

FIG. 8 shows an example of directional CLI from multiple WTRUs;

FIG. 9 is a flow chart of a method according to an embodiment for joint PMI measurement of aggressor and victim WTRUs for coordinated SB-wise beam avoidance by joint PMI;

FIG. 10 is a flow chart of a method according to an embodiment for dynamic CLI mitigation in case of multiple aggressor WTRUs, with reference to FIG. 8;

FIG. 11 is a flow chart of a method according to an embodiment for interference management resources based on SRI in estimating CSI-SINR (signal-to-interference-plus-noise ratio);

FIG. 12 is a flow chart of an embodiment of a method as described in the present document.

FIG. 13 is a flow chart of a method according to an embodiment.

FIG. 14 is an alternative presentation of FIGS. 4, 5 and 6 in one figure.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

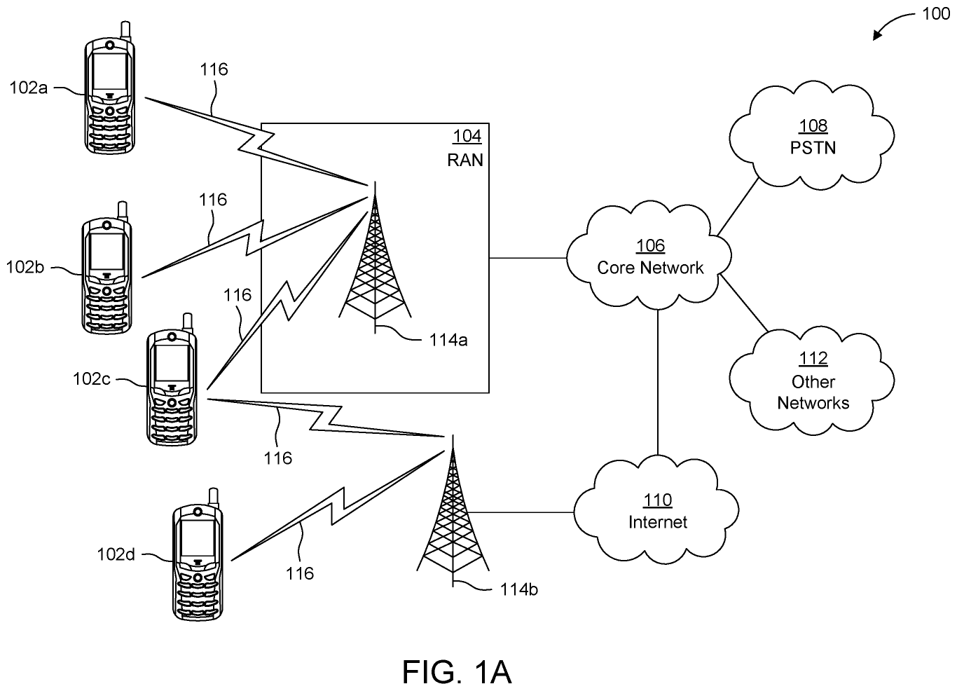

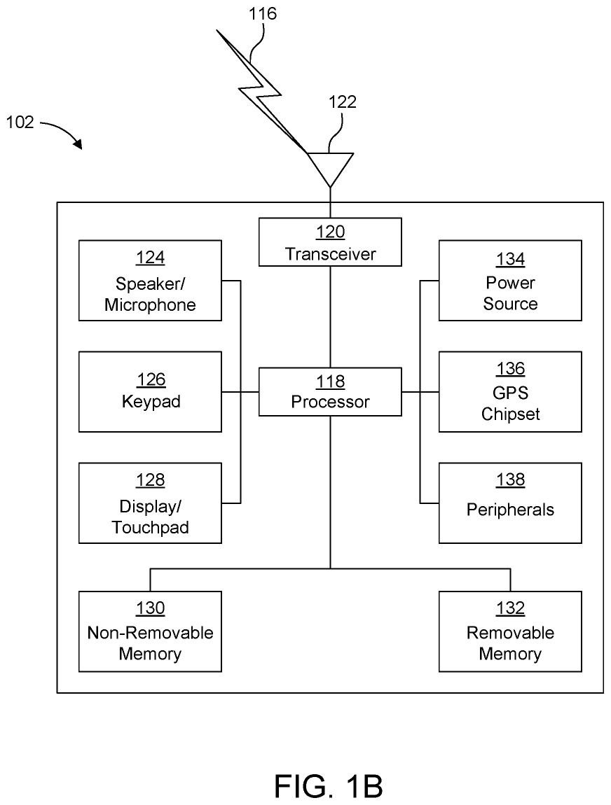

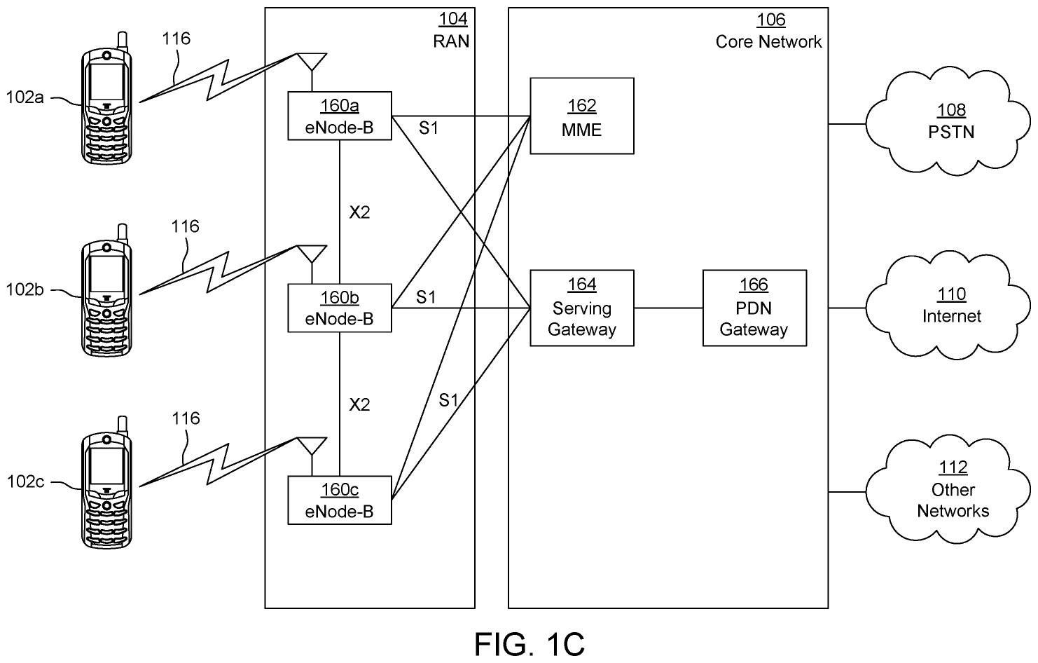

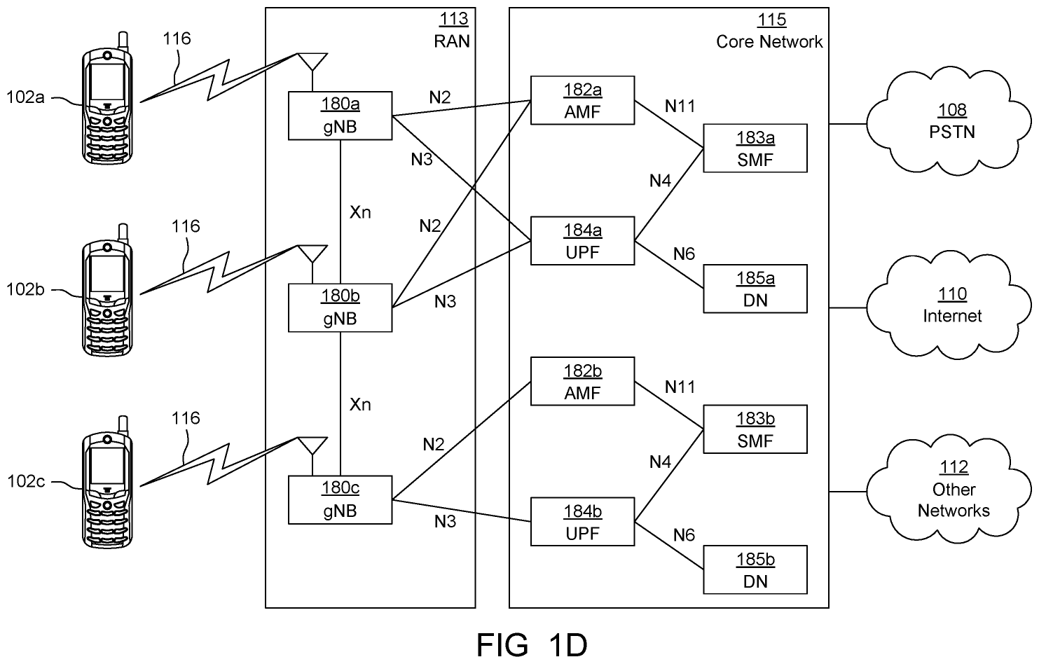

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception))

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### INTRODUCTION

### ‘aggressor’ and ‘victim’

In the following, the terms ‘aggressor’ and ‘victim’ are used. In the context of this document, these terms are used to define ‘causing RF (Radio Frequency) signal interference’ and ‘subjected to RF signal interference’ respectively. To illustrate this, an aggressor WTRU (e.g., ‘first’ WTRU) may cause RF interference in reception of RF signals (e.g., from a ‘second’ WTRU or a gNB) by a victim WTRU (e.g., a ‘third’ WTRU), or may cause RF interference in transmission of RF signals by the victim WTRU (e.g., to the second WTRU).

### ‘WTRU-Panel/Beam ID’

In the following, the term ‘WTRU-panel/beam ID’ or ‘WTRU-panel/beam index’ are used indifferently to distinguish an antenna panel/beam identifier combination. For example, a WTRU, or a gNB, may have multiple antenna panels, and each antenna panel may have multiple (transmit) beams. Each of an antenna panel and a beam may be identified by an identifier and/or an index.

### Use of ‘a’ and ‘an’

Hereinafter, ‘a’ and ‘an’ and similar are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’.

### Definition of Beam

A WTRU may transmit or receive a physical channel or reference signal (RS) according to at least one spatial domain filter. The term “beam” may be used to refer to a spatial domain filter.

The WTRU may transmit a physical channel or signal using the same spatial domain filter as the spatial domain filter used for receiving an RS (such as CSI-RS where CSI stands for Channel State Information) or a SS (Synchronization Signal) block. The WTRU transmission may be referred to as “target”, and the received RS or SS block may be referred to as “reference” or “source”. In such case, the WTRU may be said to transmit the target physical channel or signal according to a spatial relation with a reference to such RS or SS block.

The WTRU may transmit a first physical channel or signal according to the same spatial domain filter as the spatial domain filter used for transmitting a second physical channel or signal. The first and second transmissions may be referred to as “target” and “reference” (or “source”), respectively. In such case, the WTRU may be said to transmit the first (target) physical channel or signal according to a spatial relation with a reference to the second (reference) physical channel or signal.

A spatial relation may be implicit, configured by RRC (Radio Resource Control) or signaled by MAC CE (where CE stands for Control Element) or DCI (Downlink Control Information). For example, a WTRU may implicitly transmit PUSCH (Physical Uplink Shared Channel) and DM-RS (Demodulation Reference Signal) of PUSCH according to the same spatial domain filter as an SRS (Sounding Reference Signal) indicated by an SRI indicated in DCI or configured by RRC. In another example, a spatial relation may be configured by RRC for an SRS resource indicator (SRI) or signaled by MAC CE for a PUCCH (Physical Uplink Control Channel). Such spatial relation may also be referred to as a “beam indication”.

The SRS (Sounding Reference Signal) is part of two types of Reference Signal in UL (SRS and DMRS for Demodulation Reference Signal)) which give information about channel quality. A gNB may take decisions for resource allocation for UL transmission, link adaptation and decoding of data from a WTRU. The SRS is a UL reference signal transmitted by UE (e.g., to Base station). SRS may give information about the combined effect of multipath fading, scattering, Doppler and power loss of transmitted signal. For example, a Base Station may estimate the channel quality using this reference signal and may manage further resource scheduling, beam management, and power control of signal. For example, SRS may provide information (e.g., to a gNB) about the channel over full bandwidth and, using this information, a gNB takes decision for resource allocation which has better channel quality compared to other Bandwidth regions. One reference signal (DMRS) may be associated with each channel (PUCCH/PUSCH). DMRS provides information about the frequency region which is being used by PUSCH/PUCCH specifically.

The WTRU may receive a first (target) downlink channel or signal according to the same spatial domain filter or spatial reception parameter as a second (reference) downlink channel or signal. For example, such association may exist between a physical channel such as PDCCH or PDSCH (Physical Downlink Shared Channel) and its respective DM-RS. At least when the first and second signals are reference signals, such association may exist when the WTRU is configured with a quasi-colocation (QCL) assumption type D between corresponding antenna ports. Such association may be configured as a TCI (Transmission Configuration Indicator) state. A WTRU may be indicated an association between a CSI-RS or SS block and a DM-RS by an index to a set of TCI states configured by RRC and/or signaled by MAC CE. Such indication may also be referred to as a “beam indication”.

### TRP, MTRP, M-TRP

Hereafter, a TRP (e.g., Transmission and Reception Point) may be interchangeably used with one or more of TP (Transmission Point), RP (Reception Point), RRH (radio remote head), DA (distributed antenna), BS (base station), a sector (of a BS), and a cell (e.g., a geographical cell area served by a BS), but still consistent with what is described in the present document. Hereafter, Multi-TRP may be interchangeably used with one or more of MTRP, M-TRP, and multiple TRPs, but still consistent with what is described in the present document.

### Subband

Hereinafter, the term “subband” and/or “sub-band” is used to refer to a frequency-domain resource and may be characterized by at least one of the following:
A set of resource blocks (RBs);
A set of resource block sets (RB sets), e.g. when a carrier has intra-cell guard bands;
A set of interlaced resource blocks;
A bandwidth part, or portion thereof;
A carrier, or portion thereof.
   For example, a subband may be characterized by a starting RB and number of RBs for a set of contiguous RBs within a bandwidth part. A subband may also be defined by the value of a frequency-domain resource allocation field and bandwidth part index.

### XDD

Hereinafter, the term “XDD” is used to refer to a subband-wise duplex (e.g., either UL or DL being used per subband) and may be characterized by at least one of the following:
Cross Division Duplex (e.g., subband-wise FDD within a TDD band);
Subband-based full duplex (e.g., full duplex as both UL and DL are used/mixed on a symbol/slot, but either UL or DL being used per subband on the symbol/slot);
Frequency-domain multiplexing (FDM) of DL/UL transmissions within a TDD spectrum;
A subband non-overlapping full duplex (e.g., non-overlapped sub-band full-duplex);
A full duplex other than a same-frequency (e.g., spectrum sharing, subband-wise-overlapped) full duplex;
An advanced duplex method, e.g., other than (pure) TDD or FDD.

### Dynamic/Flexible TDD

Hereinafter, the term “dynamic (/flexible) TDD” is used to refer to a TDD system/cell which may dynamically (and/or flexibly) change/adjust/switch a communication direction (e.g., a downlink, an uplink, or a sidelink, etc.) on a time instance (e.g., slot, symbol, subframe, and/or the like). In an example, In a system employing dynamic/flexible TDD, a component carrier (CC) or a bandwidth part (BWP) may have one single type among ‘D’, ‘U’, and ‘F’ on a symbol/slot, based on an indication by a group-common (GC)-DCI (e.g., format 2_0) comprising a slot format indicator (SFI), and/or based on tdd-UL-DL-config-common/dedicated configurations. On a given time instance/slot/symbol, a first gNB (e.g., cell, TRP) employing dynamic/flexible TDD may transmit a downlink signal to a first WTRU being communicated/associated with the first gNB based on a first SFI and/or tdd-UL-DL-config configured/indicated by the first gNB, and a second gNB (e.g., cell, TRP) employing dynamic/flexible TDD may receive an uplink signal transmitted from a second WTRU being communicated/associated with the second gNB based on a second SFI and/or tdd-UL-DL-config configured/indicated by the second gNB. In an example, the first WTRU may determine that the reception of the downlink signal is being interfered by the uplink signal, where the interference caused by the uplink signal may refer to a WTRU-to-WTRU cross-link interference (CLI).

### CSI Components

A WTRU may report a subset of channel state information (CSI) components, where CSI components may correspond to at least a CSI-RS resource indicator (CRI), a SSB resource indicator (SSBRI), an indication of a panel used for reception at the WTRU (such as a panel identity or group identity), measurements such as L1-RSRP, L1-SINR taken from SSB or CSI-RS (e.g. cri-RSRP, cri-SINR, ssb-Index-RSRP, ssb-Index-SINR), and other channel state information such as at least a rank indicator (RI), a channel quality indicator (CQI), a precoding matrix indicator (PMI), a Layer Index (LI), and/or the like.

### Channel and/or Interference Measurements

[SSB] A WTRU may receive a synchronization signal/physical broadcast channel (SS/PBCH) block. The SS/PBCH block (SSB, also referred to as Synchronization Signal Block) may include a primary synchronization signal (PSS), secondary synchronization signal (SSS), and physical broadcast channel (PBCH). The WTRU may monitor, receive, or attempt to decode an SSB during initial access, initial synchronization, radio link monitoring (RLM), cell search, cell switching, and so forth.

[CSI-RS] A WTRU may measure and report the channel state information (CSI), wherein the CSI may include or be configured with one or more of following:
CSI Report Configuration, including one or more of the following:
   CSI report quantity, e.g., Channel Quality Indicator (CQI), Rank Indicator (RI), Precoding Matrix Indicator (PMI), CSI-RS Resource Indicator (CRI), Layer Indicator (LI), etc.;
   CSI report type, e.g., aperiodic, semi persistent, periodic;
   CSI report codebook configuration, e.g., Type I, Type II, Type II port selection, etc.;
   CSI report frequency.
CSI-RS Resource Set, including one or more of the following CSI Resource settings:
   NZP-CSI-RS Resource for channel measurement;
   NZP-CSI-RS Resource for interference measurement;
   CSI-IM Resource for interference measurement;
NZP CSI-RS Resources, including one or more of the following:
   NZP CSI-RS Resource ID;
   Periodicity and offset;
   QCL Info and TCI-state;
   Resource mapping, e.g., number of ports, density, CDM type, etc.

A WTRU may indicate, determine, or be configured with one or more reference signals. The WTRU may monitor, receive, and measure one or more parameters based on the respective reference signals. For example, one or more of the following may apply. The following parameters are non-limiting examples of the parameters that may be included in reference signal(s) measurements. One or more of these parameters may be included. Other parameters may be included.
SS-RSRP. SS reference signal received power (SS-RSRP) may be measured based on the synchronization signals (e.g., demodulation reference signal (DMRS) in PBCH or SSS). It may be defined as the linear average over the power contribution of the resource elements (RE) that carry the respective synchronization signal. In measuring the RSRP, power scaling for the reference signals may be required. In case SS-RSRP is used for L1-RSRP, the measurement may be accomplished based on CSI reference signals in addition to the synchronization signals.
CSI-RSRP. CSI-RSRP may be measured based on the linear average over the power contribution of the resource elements (RE) that carry the respective CSI-RS. The CSI-RSRP measurement may be configured within measurement resources for the configured CSI-RS occasions.
SS-SINR. SS signal-to-noise and interference ration (SS-SINR) may be measured based on the synchronization signals (e.g., DMRS in PBCH or SSS). It may be defined as the linear average over the power contribution of the resource elements (RE) that carry the respective synchronization signal divided by the linear average of the noise and interference power contribution. In case SS-SINR is used for L1-SINR, the noise and interference power measurement may be accomplished based on resources configured by higher layers.
CSI-SINR. CSI-SINR may be measured based on the linear average over the power contribution of the resource elements (RE) that carry the respective CSI-RS divided by the linear average of the noise and interference power contribution. In case CSI-SINR is used for L1-SINR, the noise and interference power measurement may be accomplished based on resources configured by higher layers. Otherwise, the noise and interference power may be measured based on the resources that carry the respective CSI-RS.
RSSI. Received signal strength indicator (RSSI) may be measured based on the average of the total power contribution in configured OFDM symbols and bandwidth. The power contribution may be received from different resources (e.g., co-channel serving and non-serving cells, adjacent channel interference, thermal noise, and so forth)
CLI-RSSI. Cross-Link interference received signal strength indicator (CLI-RSSI) may be measured based on the average of the total power contribution in configured OFDM symbols of the configured time and frequency resources. The power contribution may be received from different resources (e.g., cross-link interference, co-channel serving and non-serving cells, adjacent channel interference, thermal noise, and so forth)
SRS-RSRP. Sounding reference signals RSRP (SRS-RSRP) may be measured based on the linear average over the power contribution of the resource elements (RE) that carry the respective SRS.

### Property of a Grant or Assignment

In the following, a property of a grant or assignment may include at least one of the following:
A frequency allocation;
An aspect of time allocation, such as a duration;
A priority;
A modulation and coding scheme;
A transport block size;
A number of spatial layers;
A number of transport blocks;
A TCI state, CRI or SRI;
A number of repetitions;
Whether a repetition scheme is Type A or Type B;
Whether the grant is a configured grant type 1, type 2 or a dynamic grant;
Whether the assignment is a dynamic assignment or a semi-persistent scheduling (configured) assignment;
A configured grant index or a semi-persistent assignment index;
A periodicity of a configured grant or assignment;
A channel access priority class (CAPC);
Any parameter provided in a DCI, by MAC or by RRC for the scheduling the grant or assignment.

In the following, an indication by DCI may include at least one of the following:
An explicit indication by a DCI field or by RNTI used to mask CRC of the PDCCH.
An implicit indication by a property such as DCI format, DCI size, Coreset or search space, Aggregation Level, first resource element of the received DCI (e.g., index of first Control Channel Element), where the mapping between the property and the value may be signaled by RRC or MAC.

Hereafter, RS may be interchangeably used with one or more of RS resource, RS resource set, RS port and RS port group, but still consistent with what is described in the present document.

Hereafter, RS may be interchangeably used with one or more of SSB, CSI-RS, SRS, and DM-RS, but still consistent with what is described in the present document.

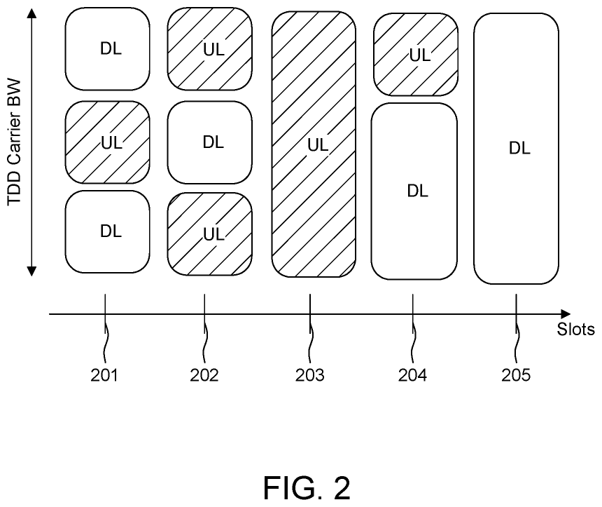

In RAN #94-e, RAN study item on New Radio (NR) duplex operation has been agreed. This technology could be the great foundation in improving conventional TDD (Time-Division Duplexing) operation by enhancing UL (Uplink) coverage, improving capacity, reducing latency, and so forth. The conventional TDD is based on splitting the time domain between the uplink and downlink. In NR Rel. 18, the feasibility of allowing full duplex, or more specifically, cross division duplex (XDD) that is subband non-overlapping full duplex at the gNB side within a conventional TDD band is investigated, see, as an example, FIG. 2. In FIG. 2, five transmission slots 201-205 in the time domain are indicated on the x-axis, and for each of the transmission slots, a combination of DL (Downlink) and UL (Uplink) transmissions, or a single DL or UL transmission, are indicated as spanning over the TDD carrier bandwidth, indicated on the y-axis.

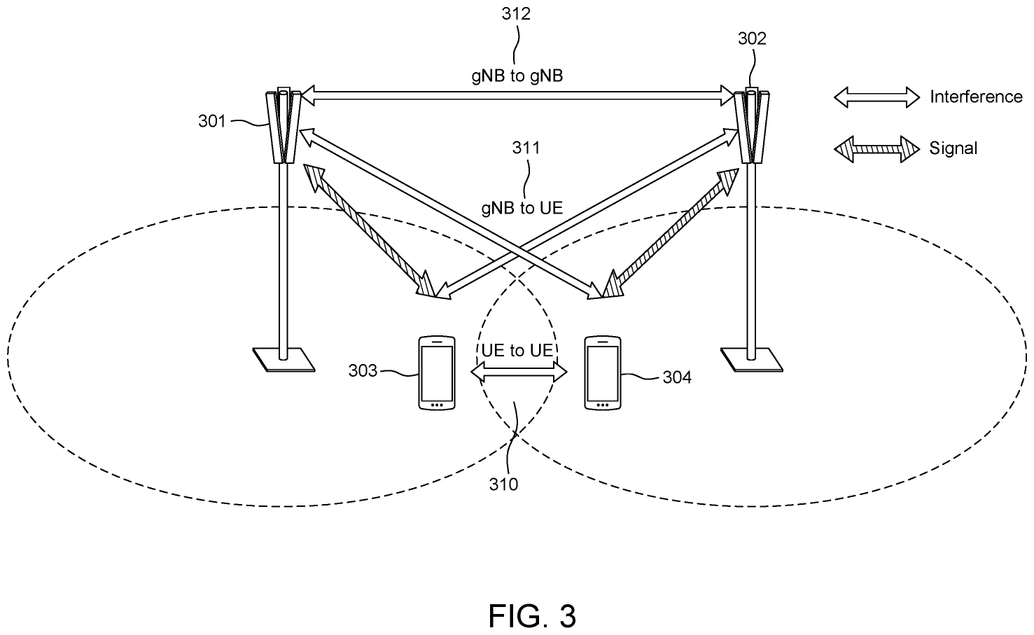

The realization of XDD is subject to resolving the key challenges raised due to cross-link interferences (CLI), see FIG. 3. Depicted in FIG. 3 are two gNBs (network nodes) 301 and 302 and two UEs (WTRUs) 303 and 304. There may be signal interference between gNBs (marked as ‘gNB to gNB’ (=‘network node to network node’), 312), between gNBs and WTRUs (marked as ‘gNB to UE’ (=‘gNB to WTRU’), 311) and between WTRUs (marked as ‘UE to UE’ (=‘WTRU to WTRU’), 310). Interference is indicated using thin arrows while signal is indicated using thick arrows. In an XDD framework, a potential aggressor cell may switch the transmission direction from UL to DL or vice-versa, causing CLI on potential victim gNBs and WTRUs.

In UL-to-DL CLI, the CLI from aggressor WTRUs may be directional, causing strong interference on one or more beam directions, while other beams may not be impacted as much. In NR Rel.17, the beam selection indication is based on CRI associated with long-term CSI-RSRP and/or CSI-SINR measurements over the wideband, where the sources of the interference are not reported. However, the victim WTRU may perform subband-wise beam reporting in order to switch to beams with lower interference and further mitigate the CLI by using companion PMI (Precoding Matrix Indicator) determination based on the beams from the aggressor WTRU in specific subbands.

Moreover, since the CLI is caused at the WTRU level, it might be dependent on the traffic scheduling and might change dynamically. This results in different WTRU behavior in case of directional CLI in XDD. Therefore, further investigation into joint beam management, designing the companion PMI to be orthogonal with the signals from aggressor WTRU, and dynamic CLI mitigation in XDD is required.

It is then interesting how to determine the best WTRU-panel/beam ID based on the CLI and/or SRS received from aggressor WTRUs, how to measure and report CSI including PMI to decrease the CLI caused by the aggressor WTRUs, and how to account for the changes in case the aggressor WTRU with dominant interference changes.

Therefore, among others, methods on joint beam management by victim WTRU and the aggressor WTRU are disclosed herewith. Also, among others, CSI feedback enhancements in interference measurement are disclosed. Moreover, among others, methods on dynamic CLI mitigation are disclosed.

### Overview

The following paragraphs summarize some embodiments that are described in further detail thereafter.

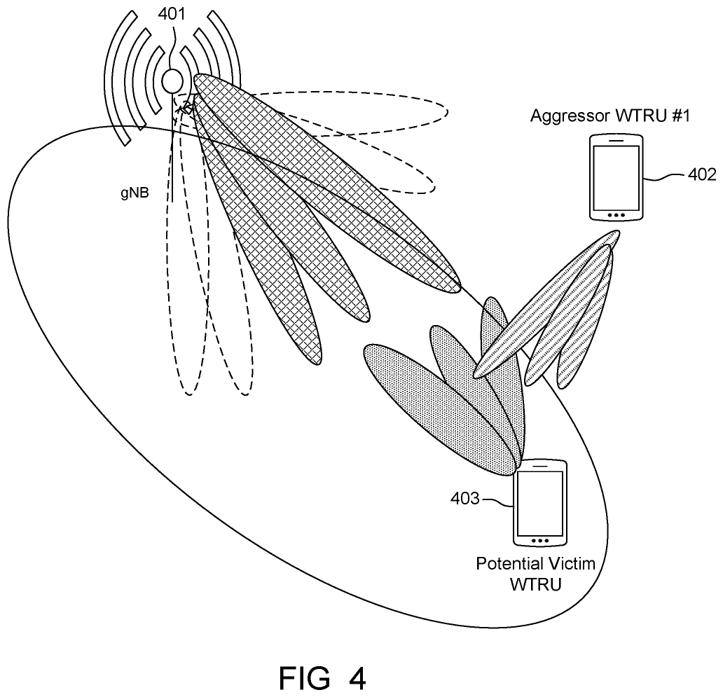

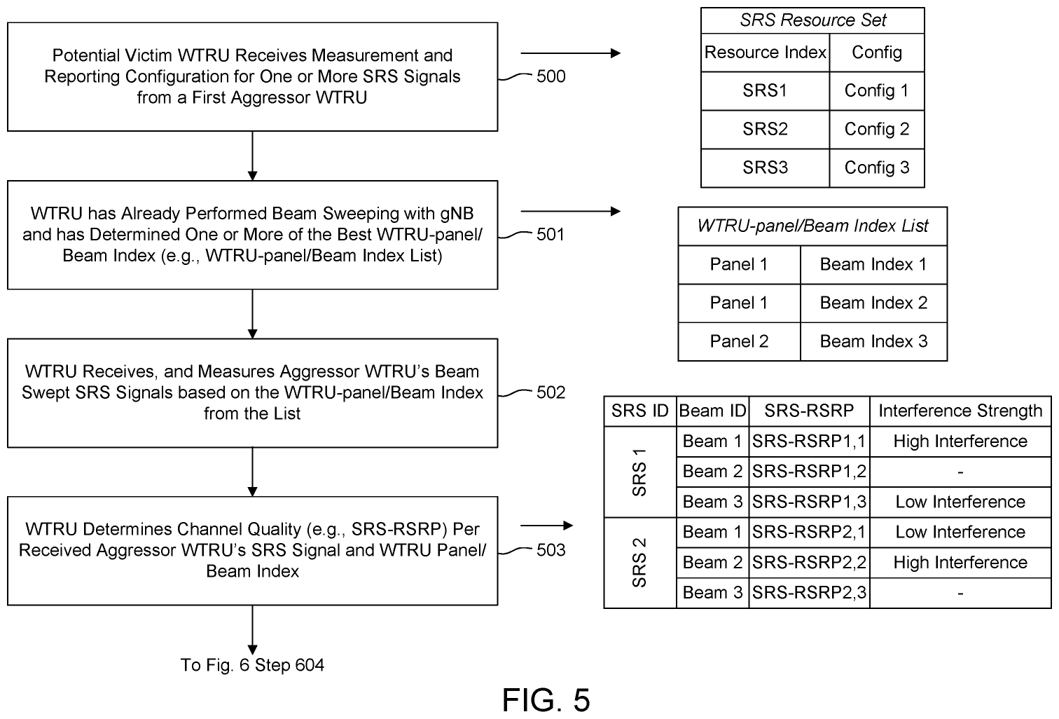

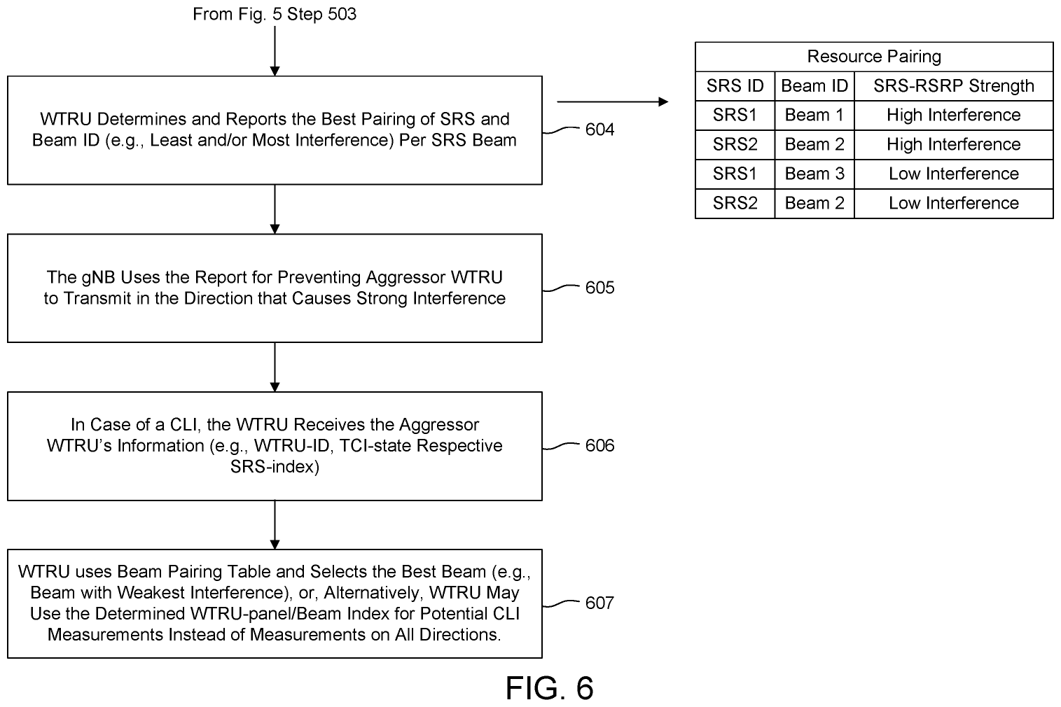

In a first embodiment, subband-wise beam reporting may be based on association of victim WTRU's CRI (CSI-RS Resource Indicator, where CSI-RS stands for Channel State Information-Reference Signal) and aggressor WTRU's SRI (SRS Resource Indicator, where SRS stands for Sounding Reference Signal). See FIG. 4, FIG. 5 and FIGS. 6.
500, a potential victim WTRU (‘victim WTRU’ for short) may receive measurement and reporting configuration (information relative to measurement configuration and reporting configuration) from a gNB (i.e., from a network or from a network node) (for reporting to the gNB) for one or more SRS signals (channel quality reference signals, e.g., SRI) that are received from a first aggressor WTRU (e.g., aggressor WTRU #1) in one or more SBs (Sub-Bands).
501, the victim WTRU may already have performed beam sweeping with gNB and may have determined and may have reported to the gNB one or more of the ‘best’ (e.g., causing least (weakest) interference at the victim WTRU, or being received with highest received power) of the victim WTRU-panel/beam indexes (e.g., CRI), accordingly.

### Joint Beam Sweeping by Potential Victim and Aggressor WTRUs

502, the victim WTRU may select one-by-one (e.g., based on a priority such as higher SS-RSRP (Synchronization Signal-Reference Signal Received Power) and/or CSI-RSRP)) the victim WTRU-panel/beam index (e.g., CRI) and measures the aggressor WTRU's beam swept SRS power/strength; in other words, the victim WTRU measures the SRS signal from the aggressor WTRU that is swept for beam measurements and beam management.
503, the victim WTRU may determine the channel quality per received aggressor WTRU's SRS signal (e.g., SRI) and victim WTRU-panel/beam index (e.g., CRI):
   For example, the victim WTRU measures the SRS-RSRP per received aggressor WTRU's SRS signal (e.g., SRI) and respective victim WTRU-panel/beam index (e.g., CRI).

### SB-Wise Beam Pairing at Potential Victim WTRU Based on the Signals from Aggressor WTRU

604, the victim WTRU may determine one or more pairs of measured SRS-RSRP (e.g., SRI) and WTRU-panel/beam index (e.g., CRI) in one or more of the SBs.
   For example, the victim WTRU may create a list to include the most and/or least interfering SRS signals by organizing the measured SRS-RSRPs in decreasing order.
      The victim WTRU may determine a first aggressor WTRU's SRS signal (e.g., SRI #1) that imposes the highest interference on a first victim WTRU-panel/beam index (e.g., CRI #1) and may include it in the list.
      Alternatively, per SRS signal (e.g., SRI #1), victim WTRU may determine a second victim WTRU-panel/beam index (e.g., CRI #3) for which the measured SRS-RSRP is the lowest (has the lowest value).
604, the victim WTRU may report, to the gNB, SB-wise CRI and associated SRI pairs for strongest and/or weakest interference.
   A flag may be used for indication of the strongest or weakest interference.
605, a gNB may use the SB-wise report along with WB (wideband) beam reporting.
   As such, the beam selection is based on WB beam reporting, where SB-wise beam pair reporting may be used based on SBs with/without CLI.
   The SB-wise beam pair reporting may be used for affecting/preventing aggressor WTRU to avoid transmitting in the direction (e.g., SRI) that causes strong interference on the victim WTRU.
      The aggressor WTRU may receive an SB-wise indicator accordingly.
606, in case of a CLI, the victim WTRU may receive the aggressor WTRU's information (e.g., aggressor's WTRU-ID, TCI-state (Transmission Configuration Indicator), or SRI)
   607, the victim WTRU then may select the best beam (causing least (weakest) interference for the victim WTRU) based on the CRI-SRI pairs determined by the victim WTRU.

Alternatively, 607, the victim WTRU may use the determined CRI-SRI pairs for potential CLI measurements instead of measurements on all directions.

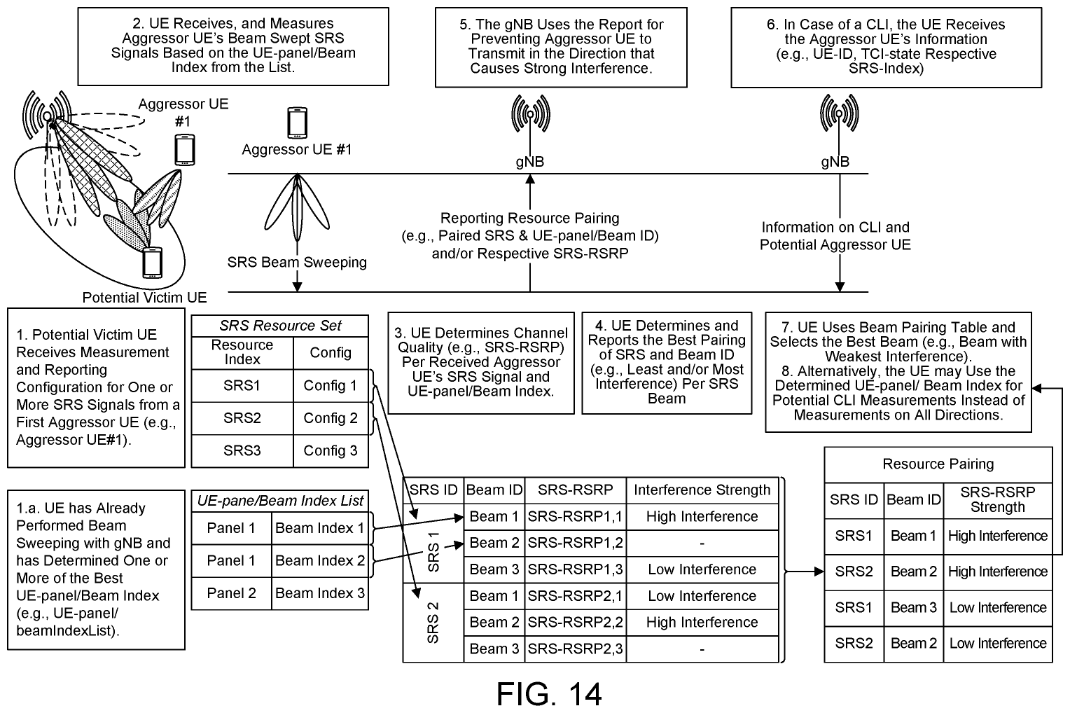

FIG. 14 depicts an alternative presentation of FIGS. 4, 5 and 6 in one figure.

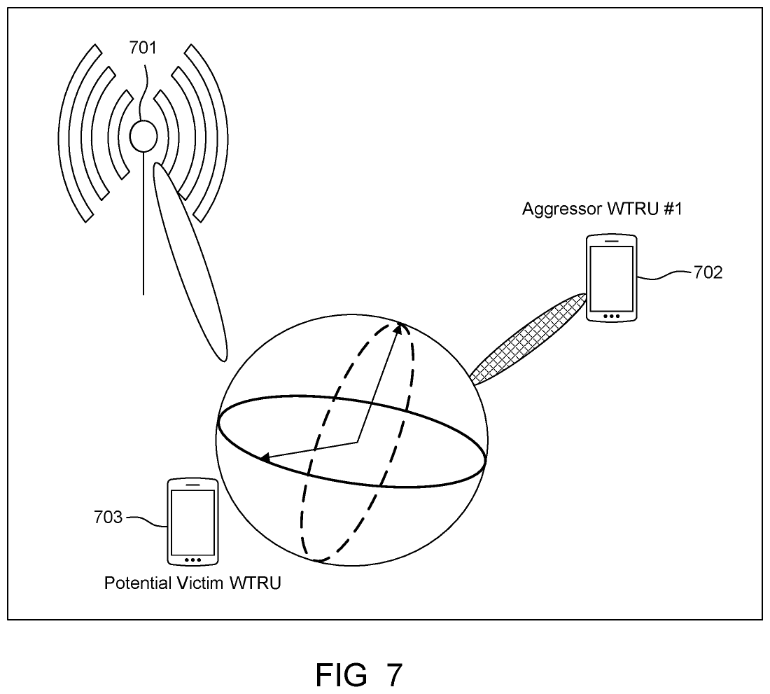

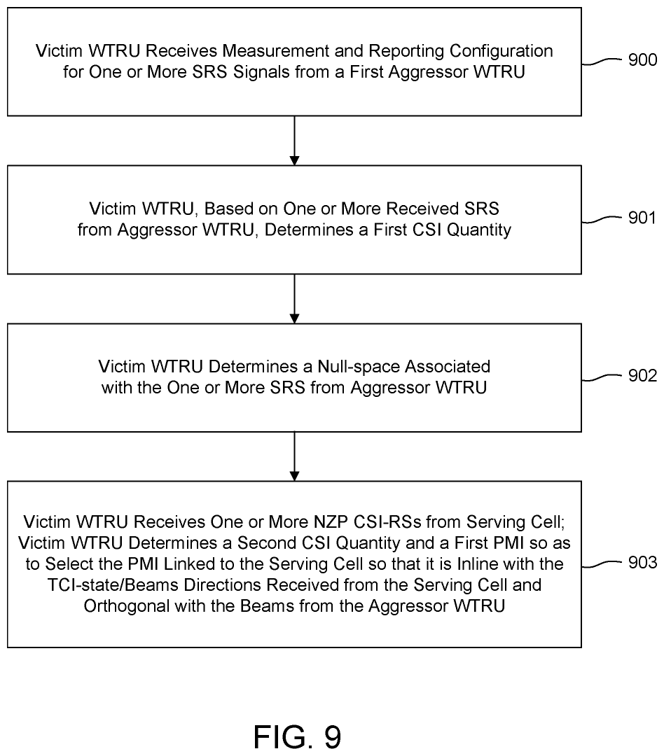

A second embodiment, see FIGS. 7 and 9, is related to method for coordinated SB-wise beam avoidance by joint PMI measurement of aggressor and victim WTRUs.
900, a potential victim WTRU (‘victim WTRU’) may receive measurement and reporting configuration for one or more SRS signals from a first aggressor WTRU (e.g., aggressor WTRU #1).
   901, the victim WTRU, based on one or more received SRS from the aggressor WTRU, determines a first CSI quantity (e.g., aggressor WTRU's channel matrix H_{CLI}).
   Theoretically, the zero CLI forces precoder for the serving cell to lie in the null space of the H_{CLI}, see FIG. 7.
   902, The victim WTRU determines a null-space associated with one or more SRS from aggressor WTRU:
      Consider the R_{CLI}=rank (H_{CLI}) as the rank of the H_{CLI}.
      Define the singular value decomposition (SVD): H_{CLI}=UΣ[V⁽¹⁾V⁽⁰⁾]^{H}
      Where, V⁽¹⁾ holds the first R^{CLI} right singular vectors.
      And V⁽⁰⁾ holds the last (n_{T}−R_{CLI}) right singular vectors, where n_{T} is the number of CSI-RS ports (antennas) at serving cell.
      V⁽⁰⁾ forms an orthogonal basis for the null space of H_{CLI}, and its columns are the candidates for the precoding matrix of the serving cell.
903, the victim WTRU receives one or more Non-Zero Power (NZP) Channel State Information Reference Signals (CSI-RSs) from the serving cell (e.g., Channel Measurement Resources (CMR)).
   The victim WTRU determines a second CSI quantity and a first precoding matrix indicator (PMI) based on the following:
      Determine the PMI to achieve minimum distance between the precoder and the serving cell's channel matrix.
      Determine the PMI to achieve minimum distance between the precoder and the null space of the aggressor WTRU's channel matrix.
903, In other words, the potential victim WTRU selects the PMI linked to the serving cell, so that it is in line with the TCI-state/beams' directions received from the serving cell and orthogonal with the beams from the aggressor WTRU.

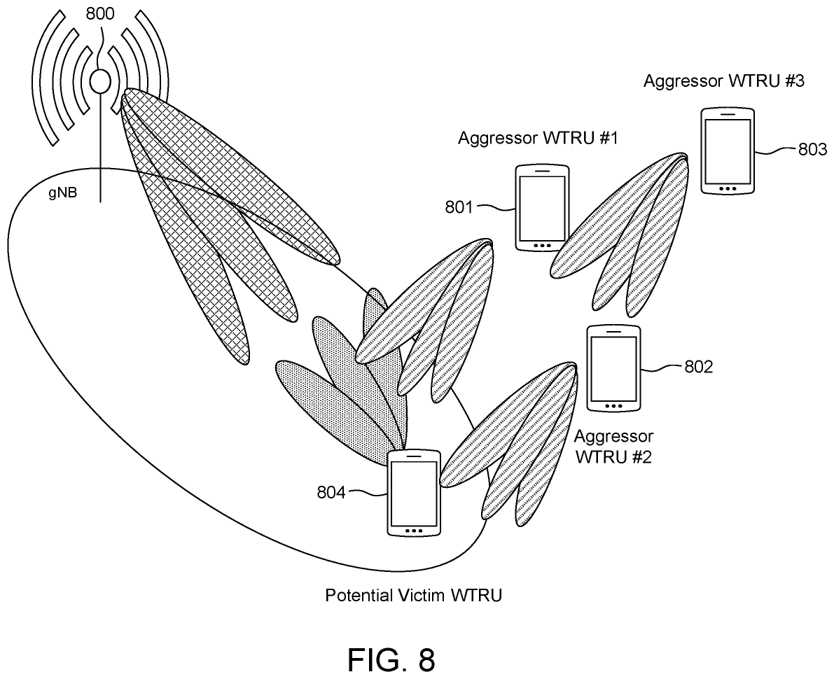

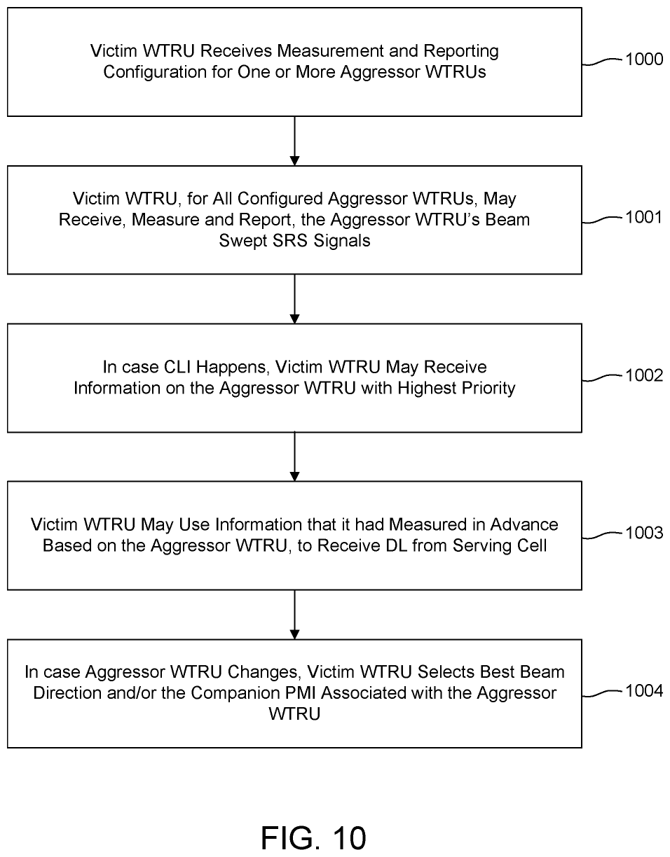

A third embodiment, see FIGS. 8 and 10, is related to a method for dynamic CLI mitigation is proposed in case of multiple aggressor WTRUs.
1000, a potential victim WTRU (‘victim WTRU’, e.g., 804) may receive measurement and reporting configuration for one or more aggressor WTRUs (e.g., aggressor WTRU #1 (801), #2 (802), and #3 (803) of FIG. 8; 800 is a gNB or network node).
   The configurations may include WTRU-ID, SRS resource Indicator (SRI), SRS measurement resources in time and frequency, SRS measurement periodicity, SRS-RSRP reporting configurations, and so forth.
1001, for all configured aggressor WTRUs, the victim WTRU may receive, may measure, and may report the aggressor WTRU's beam swept SRS signals.
1002, in case CLI happens, the victim WTRU may receive the information (e.g., MAC-CE from serving cell) on the aggressor WTRU with highest priority (e.g., aggressor WTRU #1).
   For example, the victim WTRU receives aggressor WTRU-ID and aggressor WTRU's TCI-state/beams' directions, where the aggressor WTRU is scheduled in the same SB as the victim WTRU and causes the strongest interference.
1003, the victim WTRU may use the information that it had measured in advance (e.g., SRS-RSRP), based on the aggressor WTRU, to receive DL from serving cell.
   For example, the victim WTRU selects the best beam direction and/or the companion PMI that is associated with the respective aggressor WTRU.
1004, in case the aggressor WTRU changes (e.g., aggressor WTRU #2 is prioritized due to no traffic scheduled for aggressor WTRU #1), the victim WTRU selects the best beam direction and/or the companion PMI that is associated with the respective aggressor WTRU, accordingly.

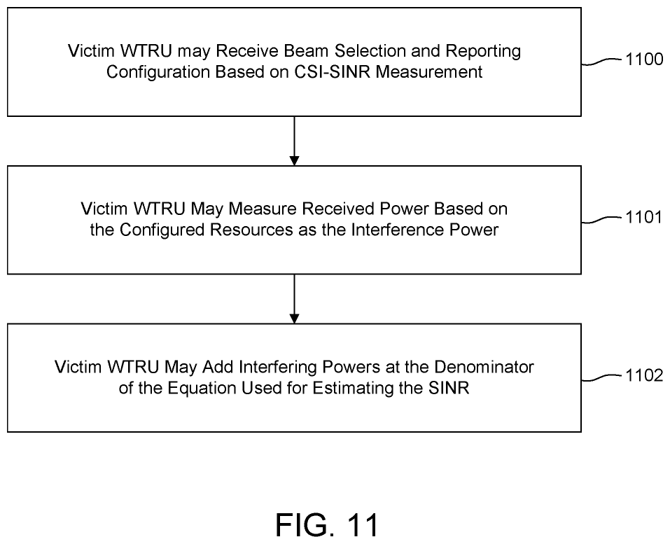

A fourth embodiment, see FIG. 11, is related to interference measurement resources (IMR) based on SRI in estimating CSI-SINR (Signal-to-Interference-plus-Noise-Ratio).
1100, a potential victim WTRU (‘victim WTRU’) may receive beam selection and reporting configuration based on CSI-SINR measurement
   One or more NZP-CSI-RS for IMR may be received.
   One or more ZP-CSI-RS for IMR may be received.
   One or more SRS Resource Indicator (SRI) may be received for IMR.
1101, the victim WTRU may measure the received power based on the configured resources as the interference power.
1102, the victim WTRU may add the interfering powers at the denominator of the equation used for estimating the SINR.

### Joint Beam Management

A WTRU may determine and/or select one or more of the best WTRU-panel/beam indexes (for DL/UL communication) with a gNB (e.g., based on measured RSRP). In an example, the WTRU may report one or more CSI-RS Resource Indicator (CRI), e.g., along with corresponding beam/channel quality metric(s), to indicate the selected best/preferred WTRU-panel/beam indexes (e.g., UE-gNB-CRI list). The best beam selection might change in the existence of the interference (e.g., CLI) in one or more of the granted (e.g., allocated, configured, indicated) resources and/or subbands. In this section, an embodiment for selecting the best/preferred beam despite interference is provided that is based on the received interference from aggressor/other WTRU(s) in respective subbands. As such, the beam selection is based on supporting subband-based beam pairing between a WTRU, a gNB, and one or more of the aggressor/other WTRUs. Therefore, the WTRU may select one or more of the best/preferred/corresponding spatial filters in respective subbands, despite the interference, see FIGS. 4, 5 and 6.

A WTRU (e.g., potential victim WTRU or ‘victim WTRU’) may use, receive, or be configured with measurement and reporting configuration for one or more (SRS) signals (e.g., SRS Resource Indicator (SRI)) from a first aggressor WTRU (e.g., aggressor WTRU #1, or without a specific aggressor WTRU-ID being indicated to the WTRU, meaning that the victim WTRU may receive the one or more signals as a potential interfering signal's signature, etc.) in one or more of the granted resources and/or subbands. In an example, the victim WTRU may receive or be configured with SRS Resource Set including at least one of the reference signals, SRS resource indexes (e.g., SRI), time and frequency resources (e.g., subbands), repetition, and so forth. Hereafter, the one or more signals may be interchangeably used with one or more SRS signals, one or more SRSs, one or more SRS resources, SRS reference signals, and SRS signals, but still consistent with what is described in the present document.

In an embodiment, a WTRU (e.g., potential victim WTRU) may be configured to receive one or more SRS signals that may be transmitted (e.g., sweeping) through different TCI-states, spatial filters and/or directions within a configured time and subband. In an example, the SRS signals (or UL RS or PUSCH or PUCCH, etc.) may be transmitted from a configured potential aggressor WTRU (e.g., aggressor WTRU #1), where the aggressor WTRU may be triggered to send SRS signals (e.g., aperiodic SRS signals) through different spatial filters/TCI states in the respective subband.

The WTRU (e.g., potential victim WTRU) may receive and measure the aggressor WTRU's beam swept SRS signals (e.g., based on the configured SRIs and TCI-states). In an embodiment, the WTRU may use and/or adjust its spatial receive filters to match the spatial filters/TCI-states that the WTRU uses for receiving signals and/or channels from the gNB (e.g., UE-gNB-CRI list).

In an example, e.g., as such, the WTRU may measure SRS-RSRP per received SRS signal, and per direction of the beams that were selected, reported, and/or identified by UE-gNB-CRIs. In an example, the WTRU may determine the SRS-RSRP in respective subbands per SRS signal (e.g., identified by SRIs) and per reception beam (e.g., identified by CRIs in UE-gNB-CRI list). For example, the WTRU may determine the SRS-RSRP for each pairing of SRI and CRI.

In an embodiment, the WTRU may determine the subband-wise pairings of the aggressor WTRU's SRI and CRI from the UE-gNB-CRI list that results in the highest/strongest interference (or interference higher than a threshold). In an example, the WTRU may determine the strongest interference (or interference higher than a threshold) per SRI and based on measured SRS-RSRP using the spatial filter corresponding to the respective CRI from the UE-gNB-CRI list in the respective subband.

Alternatively, the WTRU may determine the subband-wise pairings of the aggressor WTRU's SRI and CRI from the UE-gNB-CRI list that results in the lowest/weakest interference (or interference lower than a second threshold). In an example, the WTRU may determine the weakest interference (or interference lower than a second threshold) per SRI and based on measured SRS-RSRP using the spatial filter corresponding to the respective CRI from the UE-gNB-CRI list in the respective subband.

The WTRU (e.g., potential victim WTRU) may report the determined subband-wise SRI-CRI pairings with the strongest and/or weakest interference (and/or interference higher/lower than a threshold), per SRS beam. In other words, the WTRU (e.g., potential victim WTRU) may report the best/preferred subband-wise beam selection based on reporting respective CRI in addition to reporting the paired SRI, by which the strongest and/or weakest interference (and/or interference higher/lower than a threshold) may be imposed on the WTRU.

### Methods on Interference Mitigation

In an embodiment, a WTRU (e.g., potential victim WTRU) may receive a trigger and/or indication from a gNB that a potential interference (e.g., CLI) may be imposed on the WTRU. In an example, the WTRU may receive the indication on the time and frequency (e.g., subbands) that may be impacted by the interference, e.g., where the WTRU may receive one or more potential interfering signals' signatures (e.g., RS/sequence configuration parameters, etc.) without being indicated with a specific aggressor WTRU-ID. In another example, the WTRU may receive one or more potential aggressor WTRU's identifications (e.g., aggressor WTRU-ID) and the potential interfering signals' TCI-state or beam direction information (e.g., based on the aggressor WTRU's SRIs).

The WTRU (e.g., potential victim WTRU) may determine, identify, or be configured to use the reception spatial filter (in the respective subbands) that corresponds to the TCI-state that is associated with the indicated interfering signals' TCI-state (e.g., based on the aggressor WTRU's SRIs). In an example, upon reception of the indication on the interference, the WTRU may determine the aggressor WTRU and respective transmission TCI-state or beam direction information (e.g., based on aggressor WTRU-ID and SRI). The WTRU may determine and/or report the best beam selection based on the SRI-CRI pairing, that corresponds to the reception beam with the lowest/weakest interference (and/or interference higher/lower than a threshold) from the SRI of the indicated aggressor WTRU in the configured subband.

### Aggressor WTRU's Beam Selection Indication from gNB

In an embodiment, a second WTRU (e.g., potential aggressor WTRU) may receive signaling and/or indication to disable and/or deactivate one or more of TCI-states (e.g., UL TCI-states, joint DL/UL TCI-states to be used for both DL and UL, SRIs, beam indexes, etc.) in one or more of subbands. For example, the second WTRU may receive the indication on the time and frequency (e.g., subbands) that the second WTRU may be causing interference (e.g., on one or more potential victim WTRUs). In another example, the second WTRU may receive one or more TCI-states corresponding to the potential interfering signals' TCI-state (e.g., based on WTRU's SRIs).

The second WTRU (e.g., potential aggressor WTRU) may determine, identify, or be configured to deactivate the (transmission) spatial filter (in the respective subbands) that corresponds to the TCI-state (e.g., a UL TCI-state, a joint DL/UL TCI-state to be used for both DL and UL, an SRI, a beam index, etc.) that is associated with the indicated interfering signals' TCI-state (e.g., based on WTRU's SRIs). In an example, upon reception of the indication on the interference, the second WTRU may determine the transmission TCI-state (or spatial-filter, beam/channel coefficients to be applied on a transmission signal, etc.), e.g., based on WTRU's SRI. The indication on the deactivated TCI-state may be based on the determined SRI-CRI pairing (e.g., reported by potential victim WTRU and/or delivered to the second), where the determined SRI-CRI pairing may correspond to the reception beam, e.g., at the potential victim WTRU, with the highest/strongest interference (and/or interference higher/lower than a threshold) from the SRI of the indicated aggressor WTRU in the configured subband.

### Joint Beam Management: Beam Selection Methods

A WTRU may be configured to report CSI for at least one CSI reporting configuration, where the at least one CSI reporting configuration may include at least one channel measurement resource and at least one interference measurement resource (IMR). As described in section “CSI Feedback Enhancement for Interference Measurement” below, in a system operating using XDD, the at least one interference measurement resource may correspond to aggressor WTRUs and the at least one channel measurement resource to correspond to potential candidate beams. The WTRU may be configured to report CRI and other CSI as part of such CSI reporting configuration to inform the WTRU on the best candidate beam in presence of the interference. The WTRU may also determine its best spatial filter and reception panel for the corresponding CSI reporting configuration.

### Interference Configuration Indication for Setting Spatial Filter and Panel for Receptions

In some embodiments, at least for the reception of PDCCH, PDSCH and associated DM-RS, the WTRU may determine at least one of its spatial filter and reception panel as a function of an interference configuration in addition to a TCI state or included in a TCI state. An interference configuration may correspond to a set of at least one interference measurement resource (IMR) identified by at least one of non-zero-power CSI-RS, zero-power CSI-RS or SRS resources. The WTRU may receive at least one instance of interference configurations by MAC CE and/or RRC signaling.

For example, in an embodiment, the WTRU may be configured with at least one interference configuration indication (ICI), where each ICI may include an ICI identifier and a set of IMRs. The WTRU may determine an ICI and TCI state applicable to a PDCCH or PDSCH reception and determine a spatial filter and/or reception panel based on the applicable ICI and TCI state.

For example, in an embodiment, the WTRU may receive a configuration for at least one extended TCI state where an extended TCI state may include a configuration of at least one IMR or an indication of at least one ICI. The WTRU may determine an extended TCI state applicable to a PDCCH or PDSCH reception and determine a spatial filter and/or reception panel based on the applicable extended TCI state.

In some embodiments, the WTRU may also determine a spatial filter and transmission panel as a function of an interference configuration for the transmission of PUCCH, PUSCH and associated DM-RS.

### Determination of Interference Configuration Indication

The WTRU may determine the ICI applicable to a reception based on at least one of the following embodiments:

In an embodiment, the WTRU may receive configuration of ICI associated or included in an extended TCI state. The WTRU may determine the extended TCI state applicable to a reception based for example on existing solutions for TCI state or unified TCI state and determine the applicable ICI as the ICI associated to this TCI state.

In an embodiment, the WTRU may be configured with the ICI applicable to a reception or transmission by RRC signaling and/or MAC CE. For example, the WTRU may receive an information element for the ICI applicable to a Coreset for PDCCH, or the WTRU may receive a MAC CE indicating applicable ICI for a Coreset.

In an embodiment, the WTRU may receive an indication of applicable ICI by an explicit or implicit indication from a DCI. For example, each value of a new or existing DCI field may be mapped to an ICI identifier. The mapping may be configured by RRC and/or signaled in a MAC CE. For example, the DCI field may include a TCI state indication field. The ICI indicated by the DCI may be applicable to the indicated reception (e.g. PDSCH) or transmission (e.g. PUSCH) or to subsequent receptions and transmissions for a corresponding unified TCI instance.

In an embodiment, the WTRU may receive a configuration of ICI applicable to certain time and frequency resources. For example, the WTRU may be indicated at least one of a set of symbols or slots and a frequency range and corresponding ICI. The at least one set of symbols or slots may be indicated by a bitmap or by periodicity and offset parameters. The frequency range may be indicated by a starting resource block and number of resource blocks, by a bitmap, by a frequency domain resource allocation field and/or a bandwidth part indicator field. The indication may be signaled by RRC, MAC CE or DCI. The WTRU may determine that an ICI is applicable to a reception (or transmission) if the reception (or transmission) overlaps entirely or partially with the time and frequency resource corresponding to the ICI.

### CSI Feedback Enhancement for Interference Measurement

Hereafter, SRS resource sets may be interchangeably used with SRS resources but still consistent with what is described in the present document. Hereafter, CSI-RS resource sets may be interchangeably used with CSI-RS resources but still consistent with what is described in the present document.

In an embodiment, a WTRU (e.g., potential victim WTRU) may be configured with measurement and reporting configurations on SRS reference signals. In an example, the WTRU may receive one or more SRS Resources (e.g., transmitted from potential aggressor WTRUs) as for interference measurement resources (IMR), e.g., as a part of a CSI feedback/reporting configuration or procedure. The WTRU may measure, estimate, and/or use the received power associated with the SRS reference signal to determine the interfering signals measurements (e.g., based on an SRS-RSRP).

Alternatively, the WTRU may measure, estimate, and/or use the received power associated with the SRS reference signal to determine the interference power to be added to other sources of interfering powers (e.g., NZP-CSIRS for IMR (or NZP-CSI-RS based IMR), ZP-CSI-RS for IMR (or ZP-CSI-RS based IMR)). In an example, the WTRU may use the measured power based on the SRS reference signals to be added with (e.g., in addition to) other interference powers (e.g., the NZP-CSI-RS based IMR and/or the ZP-CSI-RS based IMR) in the denominator (e.g., as a part of interference) of an equation used to determine SINR. This may provide benefits in terms of DL (and/or UL) performance improvement in that the interference power in the equation used to determine SINR may be determined based on not only downlink intra/inter-cell (or intra/inter-TRP) interference but also an uplink (or sidelink) interference (e.g., from an aggressor WTRU) as an intra-subband CLI or inter-subband CLI, which may be measured at the WTRU (e.g., victim WTRU) based on receiving a UL signal/signature configuration being delivered from a serving gNB/TRP (of the WTRU), e.g., via a backhaul signal exchange between the serving gNB/TRP and a neighboring gNB/TRP (of the aggressor WTRU).

In an embodiment, a WTRU (e.g., potential victim WTRU) may be configured to receive one or more (WTRU-specific) SRS reference signals from one or more WTRUs (e.g., potential aggressor WTRUs) or without specific aggressor WTRU-ID(s) to measure and report respective channel and/or interference measurements in one or more subbands. Alternatively, the WTRU may be configured to receive at least one SRS reference signal that may be jointly and/or simultaneously transmitted by one or more of the WTRUs (e.g., potential aggressor WTRUs) in one or more subbands. For example, the WTRU may measure, estimate, and/or determine the received power based on the configured reference signal that may be an aggregate of the power received from all (or a group of) configured WTRUs in the respective subbands.

### CSI Feedback Enhancement for Interference Measurement: Coordinated SB-Wise Beam Avoidance by Joint PMI Measurement of Aggressor and Victim WTRUs

In an embodiment, a first WTRU (e.g., potential victim WTRU 703) may be configured to receive one or more reference signals (e.g., SRS) for measurement and reporting from a second WTRU (e.g., potential aggressor WTRU 702), see FIG. 7; a gNB (network node) is referenced by numeral 701. For example, the reference signal configuration may include reference signal index, time/frequency resources (e.g., subbands), TCI-state, and so forth. The WTRU may receive each reference signal according to their time/frequency configuration. The WTRU may measure, estimate, and/or determine the first reference signal's quantity for channel and/or interference measurement (e.g., aggressor WTRU's interference channel matrix).

A WTRU (e.g., potential victim WTRU) may be configured to receive one or more CSI reference signals (e.g., NZP-CSI-RS) for channel measurement and reporting from a gNB. For example, the CSI-RS configuration may include NZP-CSI-RS resource/index, time and frequency resources (e.g., subbands), TCI-state, and so forth. The WTRU may receive each CSI-RS resource/signal according to their time/frequency configuration. The WTRU may measure, estimate, and/or determine the second CSI quantity for channel measurement (e.g., gNB channel matrix).

In an embodiment, a first WTRU may emulate the interference from a second WTRU (e.g., CLI from the aggressor WTRU) based on the measured and/or determined channel matrix (e.g., aggressor WTRU's interference channel matrix) from the reference signal received from the second WTRU (e.g., SRS signals received from aggressor WTRU). The WTRU may determine the reference signal received from the second WTRU (e.g., potential aggressor WTRU) as the basis to calculate the CSI and/or precoding matrix index (PMI) for the connection (e.g., for communication) with gNB. As such, the WTRU may select the PMI linked to the gNB associated with the TCI-state/beams' directions received from the gNB and orthogonal with (e.g., being close to a null-space to minimize interference from) the beams received from the second WTRU (e.g., potential aggressor WTRU). The formulation (as an example) is provided as follows, that is based on the null-space of the precoding matrix selected based on the reference signal received from second WTRU for interference measurement.

In another embodiment, a WTRU may be configured to receive one or more CSI reference signals from one or more WTRUs (e.g., potential aggressor WTRUs) or without specific aggressor WTRU-ID(s) to measure and report respective channel and/or interference measurements in one or more subbands. Alternatively, the WTRU may be configured to receive at least one CSI reference signal that may be jointly and/or simultaneously transmitted by one or more of the WTRUs (e.g., potential aggressor WTRUs) in one or more subbands. For example, the WTRU may measure, estimate, and/or determine the received power based on the configured reference signal that may be an aggregate of the power received from all (or a group of) configured WTRUs in the respective subbands.

### Example Formulation

In an embodiment, a WTRU may use a procedure for the measurement of the PMI in the existence of interference (e.g. CLI). The procedure may include one or more of the following:
Considering the TCI-state associated with the serving cell's gNB, determine H_{CLI} as the aggressor WTRU's interference channel matrix.
Determine the R_{CLI}=rank (H_{CLI}) as the rank of the H_{CLI}.
Define the singular value decomposition (SVD): H_{CLI}=UΣ[V⁽¹⁾ V⁽⁰⁾]^{H}
Where, V⁽¹⁾ holds the first R_{CLI} right singular vectors.
And V⁽⁰⁾ holds the last (n_{T}−R_{CLI}) right singular vectors, where n_{T} is the number of CSI-RS ports (antennas) at serving cell.
V⁽⁰⁾ forms an orthogonal basis for the null space of H_{CLI}, and its columns are the candidates for the precoding matrix of the serving cell.
Finally, the WTRU may select and report the PMI based on one or more of the following:
   Determine the PMI to achieve minimum distance between the precoder and the serving cell's channel matrix.
   Determine the PMI to achieve minimum distance between the precoder and the null space of the aggressor WTRU's channel matrix.

### Dynamic CLI Mitigation in Case of Multiple Aggressor WTRUs

In an embodiment, a WTRU (e.g., a potential victim WTRU) may receive one or more configuration parameters for measurement and reporting, where the one or more configuration parameters may comprise at least one of the followings:
One or more DL RS resources, e.g., for channel (and/or beam) measurement
One or more IMRs, e.g., for a first part of interference measurement
One or more second (RS) resources, e.g., for a second part of interference measurement

In an embodiment, the WTRU may receive an indication/configuration that the one or more configuration parameters may be used for a CSI feedback/reporting, where a CSI (e.g., at least one of CRI, SSB index, RI, PMI, Layer-Indicator (LI), CQI, etc.) for the CSI feedback/reporting may be transmitted/reported from the WTRU.

In an embodiment, the WTRU may receive an indication/configuration that the one or more configuration parameters may be used for a beam reporting, where at least one of CRI, SSB index, (L1-)RSRP, (L1-)SINR, etc.) for the beam reporting may be transmitted/reported from the WTRU.

The WTRU may determine that the one or more second (RS) resources (e.g., the one or more SRS signals, one or more SRS resources, one or more RSs transmitted from other WTRU(s), etc.) may be transmitted from one or more other WTRUs (e.g., potential aggressor WTRUs, e.g., aggressor WTRU #1, #2, and #3, etc.). In an example, the one or more second (RS) resources may comprise one or more paired information contents, where each pair of the one or more paired information contents may comprise (or indicate) a WTRU-ID (or an index for a pair or a pairing index, etc.) and a set of (RS) resource configurations associated with the WTRU-ID. The set of resource configurations may comprise/include SRS resource Indicator(s), SRS measurement resource(s) in time and frequency, SRS measurement periodicity(s), SRS-RSRP reporting configuration(s), and so forth.

In an embodiment, the WTRU may receive the following paired information contents of the one or more second (RS) resources:
A first pair: {A first index or WTRU-ID (aggressor WTRU #1) and a first set of (RS) resource configuration}
A second pair: {A second index or WTRU-ID (aggressor WTRU #2) and a second set of (RS) resource configuration}
A third pair: {A third index or WTRU-ID (aggressor WTRU #3) and a third set of (RS) resource configuration}
Etc.

In an example, the WTRU may receive/measure the one or more second (RS) resources, e.g., which may comprise/indicate one or more beam-swept SRS transmissions (from at least one of the aggressor WTRU #1, #2, #3, and so on). In response to receiving/measuring the one or more second (RS) resources (e.g., as beam-swept SRS transmissions from multiple aggressor WTRUs), the WTRU may report/transmit a measurement result of the one or more second (RS) resources, where the measurement result may comprise:
Selected/preferred (or not-preferred) one or more WTRU-IDs (of the one or more paired information contents), each with a quality-related metric value (e.g., SRS-RSRP, Layer-1 (L1)-SRS-RSRP, CLI-RSSI, and/or the like) determined based on an RS resource (e.g., an SRI) and one or more subbands (e.g., where selected/preferred subband(s) of the one or more subbands may also be reported).

In an embodiment, the WTRU may receive an indication, from a gNB/TRP (e.g., via a MAC-CE and/or DCI), of one or more pairing indexes, e.g., the first index (as aggressor WTRU #1) (of the one or more paired information contents) of the one or more second (RS) resources. In response to receiving the indication of the first index (as aggressor WTRU #1), the WTRU may report/transmit a first measurement result comprising one or more quality-related metric values (e.g., SRS-RSRP, Layer-1 (L1)-SRS-RSRP, CLI-RSSI, and/or the like), each with corresponding RS resource (e.g., SRI) being transmitted (from the aggressor WTRU #1) associated with the first index, determined based on one or more subbands.

In an example, the WTRU may receive an indication, from a gNB/TRP (e.g., via a MAC-CE and/or DCI), of one or more pairing indexes, e.g., the first index (as aggressor WTRU #1) and the second index (as aggressor WTRU #2) (of the one or more paired information contents) of the one or more second (RS) resources. In response to receiving the indication of the first index (as aggressor WTRU #1) and the second index (as aggressor WTRU #2), the WTRU may report/transmit a second measurement result comprising:
first one or more quality-related metric values (e.g., SRS-RSRP, Layer-1 (L1)-SRS-RSRP, CLI-RSSI, and/or the like), each with corresponding RS resource (e.g., SRI) being transmitted (from the aggressor WTRU #1) associated with the first index, determined based on one or more subbands, and
second one or more quality-related metric values (e.g., SRS-RSRP, Layer-1 (L1)-SRS-RSRP, CLI-RSSI, and/or the like), each with corresponding RS resource (e.g., SRI) being transmitted (from the aggressor WTRU #2) associated with the second index, determined based on one or more subbands.

In an example, the WTRU may receive an indication, from a gNB/TRP (e.g., via a MAC-CE and/or DCI), of one or more pairing indexes, e.g., the second index (as aggressor WTRU #2) and the third index (as aggressor WTRU #3) (of the one or more paired information contents) of the one or more second (RS) resources. The indication of changing the one or more pairing indexes may be due to that the aggressor WTRU #1 may not have buffered traffic and may be due to that the aggressor WTRU #3 may have (new) buffered traffic. In response to receiving the indication of the second index (as aggressor WTRU #2) and the third index (as aggressor WTRU #3), the WTRU may report/transmit a third measurement result comprising:
second one or more quality-related metric values (e.g., SRS-RSRP, Layer-1 (L1)-SRS-RSRP, CLI-RSSI, and/or the like), each with corresponding RS resource (e.g., SRI) being transmitted (from the aggressor WTRU #2) associated with the second index, determined based on one or more subbands, and
third one or more quality-related metric values (e.g., SRS-RSRP, Layer-1 (L1)-SRS-RSRP, CLI-RSSI, and/or the like), each with corresponding RS resource (e.g., SRI) being transmitted (from the aggressor WTRU #3) associated with the third index, determined based on one or more subbands.

The WTRU may determine that the indication (e.g., via a MAC-CE and/or DCI), of one or more pairing indexes (e.g., being determined/selected when CLI happens), may be a priority indication that the indicated one or more pairing indexes are to be applied for determining a corresponding measurement result (e.g., the first, the second, or the third measurement result) to be reported by the WTRU. In an example, the WTRU may determine the aggressor WTRU's TCI-state/beams' directions based on the indicated one or more pairing, where the aggressor WTRU(s) may be scheduled in the same SB as the WTRU (e.g., victim WTRU) and causes the strongest interference(s) to the WTRU. The WTRU may apply a measurement result (e.g., at least one of the first, the second, and the third measurement results) to determine a (preferred) CSI to be reported (e.g., based on the CSI feedback/reporting) or a (preferred) beam (with a quality metric) to be reported (e.g., based on the beam reporting), where the determining may be based on the measurement result (e.g., a CLI, for a second part of interference measurement) in addition to the at least one of the one or more DL RS resources, e.g., for channel (and/or beam) measurement and the one or more IMRs, e.g., for a first part of interference measurement.

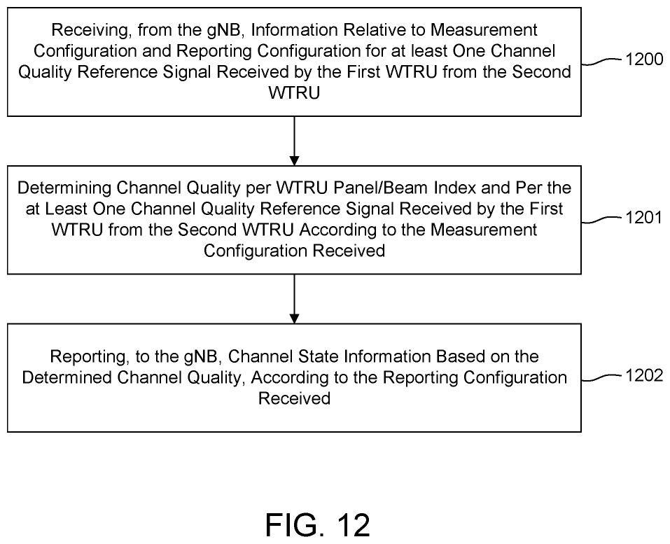

FIG. 12 is a flow chart of a method according to an embodiment of a method, implemented by a first wireless transmit-receive unit, WTRU, wherein wireless communication between the first WTRU and a gNB is subject to radio signal interference caused by a second WTRU. See also FIG. 4; in FIG. 4, the gNB (network node) is represented by ‘gNB’ (401), the first WTRU is represented by the ‘potential victim WTRU’ (403), the second WTRU is represented by ‘Aggressor WTRU #1’ (402). In 1201, the first WTRU receives, from the gNB, information relative to measurement configuration and reporting configuration for at least one channel quality reference signal received by the first WTRU from the second WTRU. In 1202, the first WTRU determines channel quality per WTRU panel/beam index and per the at least one channel quality reference signal received by the first WTRU from the second WTRU according to the measurement configuration received. In 1203, the first WTRU reports, to the gNB, channel state information based on the determined channel quality, according to the reporting configuration received. The reporting can then for example be used by the gNB to instruct the second WTRU to avoid transmitting in the direction that causes strong interference on the first WTRU.

According to a further embodiment, the method includes, in the determining channel quality per WTRU panel/beam index and per the at least one channel quality reference signal received from the second WTRU, determining a pair of WTRU panel/beam index and channel quality reference signal received from the second WTRU causing a highest interference on the wireless communication between the first WTRU and the gNB, and reporting, to the gNB, channel state information for the determined pair.

According to a further embodiment, the method includes, in the determining channel quality per WTRU panel/beam index and per the at least one channel quality reference signal received from the second WTRU, determining a pair of WTRU panel/beam index and channel quality reference signal received from the second WTRU having a lowest sounding reference signal-reference signal received power, and reporting, to the gNB, channel state information for the determined pair.

According to a further embodiment, the at least one channel quality reference signal received from the second WTRU is according to a sounding reference signal-resource indicator.

According to a further embodiment, the WTRU panel/beam index is according to channel state information—resource signal resource indicator.

According to a further embodiment, the measurement configuration is sounding reference signal—reference signal received power.

According to a further embodiment, the channel state information corresponds to at least one of:
a channel state information-reference signal resource indicator;
a synchronization signal block resource indicator;
an indication of an antenna panel used for reception at the first WTRU;
a layer one, L1, reference signal received power obtained from synchronization signal block or channel state information-resource signal resource indicator measurements;
a layer one, L1, signal-to-interference-plus-noise ratio obtained from synchronization signal block or channel state information-resource signal resource indicator measurements;
a rank indicator;
a channel quality indicator;
precoding matrix indicator;
a layer index.

There is further disclosed a first wireless transmit-receive unit, WTRU, subject to radio signal interference in wireless communication between the first WTRU and a gNB caused by a second WTRU. The first WTRU comprises at least one processor configured to receive, from the gNB, information relative to measurement configuration and reporting configuration for at least one channel quality reference signal; to determine channel quality per WTRU panel/beam index and per the at least one channel quality reference signal received from the second WTRU according to the measurement configuration received; and to report, to the gNB, channel state information based on the determined channel quality, according to the reporting configuration received.

According to an embodiment of the first WTRU, the at least one processor is further configured to, in the determining channel quality per WTRU panel/beam index and per the at least one channel quality reference signal received from the second WTRU: determine a pair of WTRU panel/beam index and channel quality reference signal received from the second WTRU causing a highest interference on the wireless communication between the first WTRU and the gNB; and to report, to the gNB, channel state information for the determined pair.

According to an embodiment of the first WTRU, the at least one processor is configured to, in the determining channel quality per WTRU panel/beam index and per the at least one channel quality reference signal received from the second WTRU: determine a pair of WTRU panel/beam index and channel quality reference signal received from the second WTRU having a lowest sounding reference signal—reference signal received power; and to report, to the gNB, channel state information for the determined pair.

According to an embodiment of the first WTRU, the at least one channel quality reference signal received from the second WTRU is according to a sounding reference signal-resource indicator.

According to an embodiment of the first WTRU, the WTRU panel/beam index is according to channel state information—resource signal resource indicator.

According to an embodiment of the first WTRU, the measurement configuration is sounding reference signal—reference signal received power.

According to an embodiment of the first WTRU, the channel state information corresponds to at least one of:
a channel state information—reference signal resource indicator;
a synchronization signal block resource indicator;
an indication of an antenna panel used for reception at the first WTRU;
a layer one, L1, reference signal received power obtained from synchronization signal block or channel state information-resource signal resource indicator measurements;
a layer one, L1, signal-to-interference-plus-noise ratio obtained from synchronization signal block or channel state information-resource signal resource indicator measurements;
a rank indicator;
a channel quality indicator;
precoding matrix indicator;
a layer index.

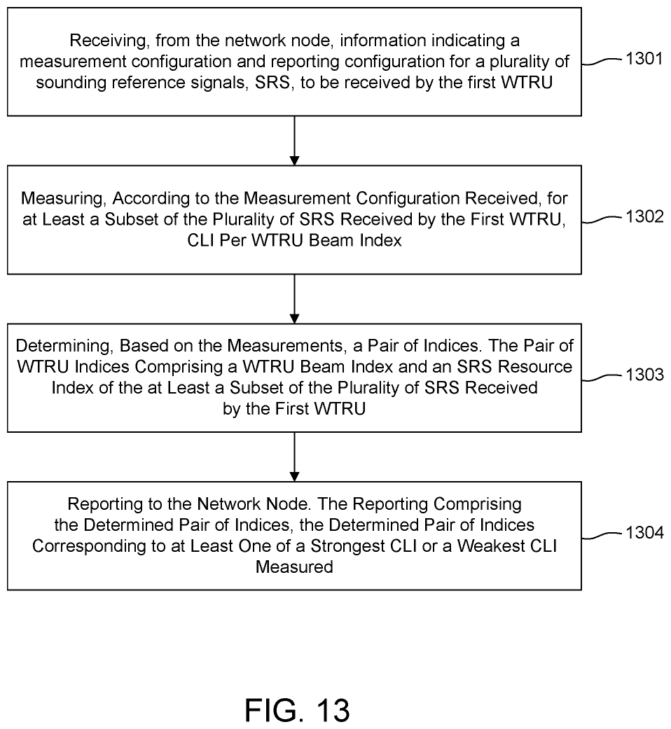

FIG. 13 is a flow chart of a method according to an embodiment.

The method is implemented by a first wireless transmit-receive unit, WTRU. Wireless communication between the first WTRU and a network node is subject to cross-link interference, CLI. The method comprises in 1301, receiving, from the network node, information indicating a measurement configuration and reporting configuration for a plurality of sounding reference signals, SRS, to be received by the first WTRU.

The method comprises, in 1302, measuring, according to the measurement configuration received, for at least a subset of the plurality of SRS received by the first WTRU, CLI per WTRU beam index.

The method comprises, in 1303, determining, based on the measurements, a pair of indices. The pair of WTRU indices comprising a WTRU beam index and an SRS resource index of the at least a subset of the plurality of SRS received by the first WTRU.

The method comprises, in 1304, reporting to the network node. The reporting comprising the determined pair of indices, the determined pair of indices corresponding to at least one of a strongest CLI or a weakest CLI measured.

According to an embodiment of the method, the CLI is associated with a second WTRU, and the at least a subset of the plurality of SRS is received from the second WTRU.

According to an embodiment of the method, the WTRU beam index identifies a combination of an antenna panel associated with the first WTRU and a beam index of a beam related to the antenna panel.

According to an embodiment of the method, the WTRU beam index is associated with a WTRU antenna panel, as indicated in the received measurement configuration.

According to an embodiment of the method, the SRS resource index is according to a sounding reference signal-resource indicator, SRI.

According to an embodiment of the method, the determined pair of indices is indicated by channel state information-reference signal, CSI-RS, resource indicator.

According to an embodiment of the method, the measuring comprises measurement of sounding reference signal-reference signal received power, SRS-RSRP.

The present disclosure also relates to a first wireless transmit-receive unit (WTRU) comprising at least one processor. The at least one processor being configured to receive, from the network node, information indicating a measurement configuration and reporting configuration for a plurality of sounding reference signals, SRS, to be received by the first WTRU.

The at least one processor being configured to measure, according to the measurement configuration received, for at least a subset of the plurality of SRS received by the first WTRU, CLI per WTRU beam index.

The at least one processor being configured to determine, based on the measurements, a pair of indices comprising a WTRU beam index and an SRS resource index of the at least a subset of the plurality of SRS received by the first WTRU.

The at least one processor being configured to report to the network node, the reporting comprising the determined pair of indices, the determined pair of indices corresponding to at least one of a strongest CLI or a weakest CLI measured.

According to an embodiment, the at least one processor is configured to associate the CLI with a second WTRU; and to receive the at least a subset of the plurality of SRS from the second WTRU.

According to an embodiment, the at least one processor is configured to identify the WTRU beam index by a combination of an antenna panel associated with the first WTRU and a beam index of a beam related to the antenna panel.

According to an embodiment, the WTRU beam index is associated with a WTRU antenna panel, as indicated in the received measurement configuration.

According to an embodiment, the SRS resource index is according to a sounding reference signal-resource indicator, SRI.

According to an embodiment, the determined pair of indices is indicated by channel state information-reference signal, CSI-RS, resource indicator.

According to an embodiment, the measuring comprises measurement of sounding reference signal-reference signal received power, SRS-RSRP.

### Conclusion

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

1-14. (canceled)

15. A method, implemented by a first wireless transmit-receive unit (WTRU) wherein wireless communication between the first WTRU and a network node is subject to cross-link interference (CLI), the method comprising:
determining one or more WTRU panel/beam indexes based on one or more wideband (WB) reference signal (RS) measurements;
receiving, from the network node, a measurement configuration and a reporting configuration for a first sub-band (SB), for a second SB and for at least one sounding reference signal (SRS) received by the first WTRU;
measuring, according to the measurement configuration received, for the first SB and for the second SB, based on the at least one SRS received by the first WTRU, CLI per the one or more WTRU panel/beam indexes determined based on one or more WB RS measurements;
determining a first pair of WTRU panel/beam index and SRS received based on CLI measured for the first SB, and determining a second pair of WTRU panel/beam index and SRS received based on CLI measured for the second SB; and
reporting, according to the configuration received, the determined first pair of WTRU panel/beam index and the determined second pair of WTRU panel/beam index to the network node.

16. The method of claim 15, wherein the reporting comprises WTRU panel/beam index and an SRS resource index of the determined first pair of WTRU panel/index and of the determined second pair of WTRU panel/beam index.

17. The method of claim 15, wherein the first pair of WTRU panel/beam index and the second pair of WTRU panel/beam index are determined according to a strongest/weakest CLI at the first WTRU.

18. The method of claim 15, wherein the CLI is associated with a second WTRU, and the at least one SRS is received from the second WTRU.

19. The method of claim 15, wherein the one or more WTRU beam/panel indexes identify a combination of an antenna panel associated with the first WTRU and a beam index of a beam related to the antenna panel.

20. The method of claim 16, wherein the SRS resource index is according to a SRS-resource indicator, SRI.

21. The method of claim 15, wherein the determined first pair of WTRU panel/beam index and the determined second pair of WTRU panel/beam index are indicated during the reporting through channel state information-reference signal (CSI-RS) resource indicator.

22. The method of claim 15, wherein the measuring comprises measurement of SRS-reference signal received power (SRS-RSRP).

23. A first wireless transmit-receive unit, WTRU, subject to cross-link interference (CLI) in wireless communication between the first WTRU and a network node, the first WTRU comprising at least one processor configured to:
determine one or more WTRU panel/beam indexes based on one or more wideband (WB) reference signal (RS) measurements;
receive, from the network node, a measurement configuration and a reporting configuration for a first sub-band (SB), for a second SB and for at least one sounding reference signal (SRS) received by the first WTRU;
measure, according to the measurement configuration received, for the first SB and for the second SB, based on the at least one SRS received by the first WTRU, CLI per the one or more WTRU panel/beam indexes determined based on the one or more WB RS measurements;
determine a first pair of WTRU panel/beam index and SRS received based on CLI measured for the first SB, and determine a second pair of WTRU panel/beam index and SRS received based on CLI measured for the second SB; and
report, according to the configuration received, the determined first pair of WTRU panel/beam index and the determined second pair of WTRU panel/beam index to the network node.

24. The first WTRU of claim 23, wherein the at least one processor is configured to comprise, in the report, a WTRU panel/beam index and an SRS resource index of the determined first pair of WTRU panel/beam index and of the determined second pair of WTRU panel/beam index.

25. The first WTRU of claim 23, wherein the at least one processor is configured to determine the first pair of WTRU panel/beam index and the second pair of WTRU panel/beam index according to a strongest/weakest CLI at the first WTRU.

26. The first WTRU of claim 23, wherein the at least one processor is configured to:
associate the CLI with a second WTRU; and receive the at least one SRS from the second WTRU.

27. The first WTRU of claim 23, wherein the one or more WTRU panel/beam indexes identify a combination of an antenna panel associated with the first WTRU and a beam index of a beam related to the antenna panel.

28. The first WTRU of claim 24, wherein the SRS resource index is according to an SRS-resource indicator, SRI.

29. The first WTRU of claim 23, wherein the at least one processor is configured to indicate, during the reporting, the determined first pair of WTRU panel/beam index and the determined second pair of WTRU panel/beam index through channel state information-reference signal (CSI-RS) resource indicator.
